(19) United States
(12) Patent Application Publication
(10) Pub. No.: US 2007/0024577 A1
(43) Pub. Date: Feb. 1, 2007

(54) Method of controlling software functions, electronic device, and computer program product

(76) Inventor: Mikko Nurmi, Tampere (FI)

Correspondence Address: Hollingsworth & Funk, LLC, Suite 125, 8009 34th Avenue South, Minneapolis, MN, 55425, US

(21) Appl. No.: 11/191,152

(22) Filed: Jul. 27, 2005

(51) Int. Cl. G09G 5/00

(52) U.S. Cl. 345/156

(57) ABSTRACT

The invention relates to a method of controlling software functions, to an electronic device, and to a computer program product. The electronic device comprises a processing unit for controlling functions of the electronic device, a display coupled to the processing unit, and a control wheel for giving control commands for controlling software functions, the software functions of the electronic device being controllable by detected turning functions of the control wheel. The electronic device is further configured to: determine more than one selection areas on the control wheel; associate the se-lection areas with given software functions; detect from which selection area the turning function starts when a turning function of the control wheel is detected; and perform predetermined software functions on the basis of from which given selection area the turning function is detected to start.

### BACKGROUND OF THE INVENTION

1. Field of the Invention

The invention relates to a method of controlling software functions of an electronic device, to an electronic device, to a computer program product, and to a computer program distribution medium.

2. Description of the Related Art

The significance of different user interfaces, for example, displays, touch screens and input devices, is becoming more and more important in portable electronic devices. Portable devices are increasingly used with different applications, for example. The usability of a user interface has become a critical aspect in controlling the functions of the electronic devices. The sizes of different portable electronic devices are limited, and therefore also the sizes of the displays and input devices used in such devices are usually much smaller than those used in personal computers, for example. Due to the limited sizes of the portable electronic devices, user-friendlier user interfaces for such devices are being developed.

One example of known user-friendly user interfaces in electronic devices is a control wheel that is used for controlling software functions of a device. The control wheel is used such that detecting selected turning directions of the control wheel enables control of the software functions of the electronic device. However, before using the control wheel, the user of the device must first select which given software function of the device he/she wishes to control. If, for example, the user wishes to adjust the volume of the device, he/she must first activate volume adjustment before he/she can make volume adjustments by using the control wheel. Later, the user may wish to select another software function to be controlled and then he/she has to activate the other function before using the control wheel. There may also be several control wheels for different software functions but this takes a lot of space in the display area.

### SUMMARY OF THE INVENTION

The object of the invention is to provide an improved method of controlling software functions of an electronic device, an improved electronic device, a computer program product and a computer program distribution medium.

According to an aspect of the invention, there is provided a method of controlling software functions of an electronic device, the electronic device comprising a display and a control wheel, and the software functions of the electronic device being controllable by detected turning functions of the control wheel. The method comprises: determining more than one selection areas on the control wheel, associating the selection areas with given software functions; detecting from which selection area the turning function starts when a turning function of the control wheel is detected; and performing predetermined software functions on the basis of from which given selection area the turning function is detected to start.

According to another aspect of the invention, there is provided an electronic device comprising a processing unit for controlling functions of the electronic device; a display coupled to the processing unit; and a control wheel for giving control commands for controlling software functions, the software functions of the electronic device being controllable by detected turning functions of the control wheel. The processing unit is configured to: determine more than one selection areas on the control wheel; associate the selection areas with given software functions; detect from which selection area the turning function starts when a turning function of the control wheel is detected; and perform predetermined software functions on the basis of from which given selection area the turning function is detected to start.

According to another embodiment of the invention, there is provided a computer program product encoding a computer process for providing controlling software functions of an electronic device, the computer process comprising controlling the software functions of the electronic device on the basis of detected turning functions of a control wheel. The process further comprises: determining more than one selection areas on the control wheel; associating the selection areas with given software functions; detecting from which selection area the turning function starts when a turning function of the control wheel is detected; and performing predetermined software functions on the basis of from which given selection area the turning function is detected to start.

According to an embodiment of the invention, there is provided a computer program distribution medium readable by a computer and encoding a computer program of instructions for executing a computer process for controlling software functions of an electronic device, the process comprising controlling the software functions of the electronic device on the basis of detected turning functions of a control wheel. The process further comprises: determining more than one selection area on the control wheel; associating the selection areas with given software functions; detecting from which selection area the turning function starts when a turning function of the control wheel is detected; and performing predetermined software functions on the basis of from which given selection area the turning function is detected to start.

According to an embodiment of the invention, there is provided an electronic device comprising processing means for controlling functions of the electronic device; display means; and a control wheel for giving control commands for controlling software functions, the software functions of the electronic device being controllable by detected turning functions of the control wheel. The electronic device further comprises: processing means for determining more than one selection area on the control wheel; associating means for associating the selection areas with given software functions; detecting means for detecting from which selection area the turning function starts when a turning function of the control wheel is detected; and processing means for performing predetermined software functions on the basis of from which given selection area the turning function is detected to start.

The embodiments of the invention provide several advantages. Using a simple tool enables controlling of various software functions. From the point of view of the user, the method is quick to use. The amount of software functions that can be controlled with a control wheel is diversified in a user-friendly manner.

### BRIEF DESCRIPTION OF THE DRAWINGS

In the following, the invention will be described in greater detail with reference to preferred embodiments and the accompanying drawings, in which

FIG. 1 shows an example of an electronic device;

FIGS. 2A and 2B illustrate examples of a user interface of embodiments of the invention; and

FIG. 3 shows an example of a method of controlling software functions of an electronic device.

### DETAILED DESCRIPTION OF THE PREFERRED EMBODIMENTS

The embodiments of the invention are applicable to electronic devices, such as a mobile station used as a terminal in telecommunicaton systems comprising one or more base stations and terminals communicating with the base stations, for example. The device may be used for short-range communication implemented with a Bluetooth chip, an infrared or WLAN connection, for example. The electronic device is, for example, a portable telephone or another device including telecommunication means, such as a portable computer, a personal computer, a handheld computer or a smart telephone. The portable electronic device may be a PDA (Personal Digital Assistant) device including the necessary telecommunication means for establishing a network connection, or a PDA device that can be coupled to a mobile telephone, for instance, for a network connection. The portable electronic device may also be a computer or PDA device including no telecommunication means.

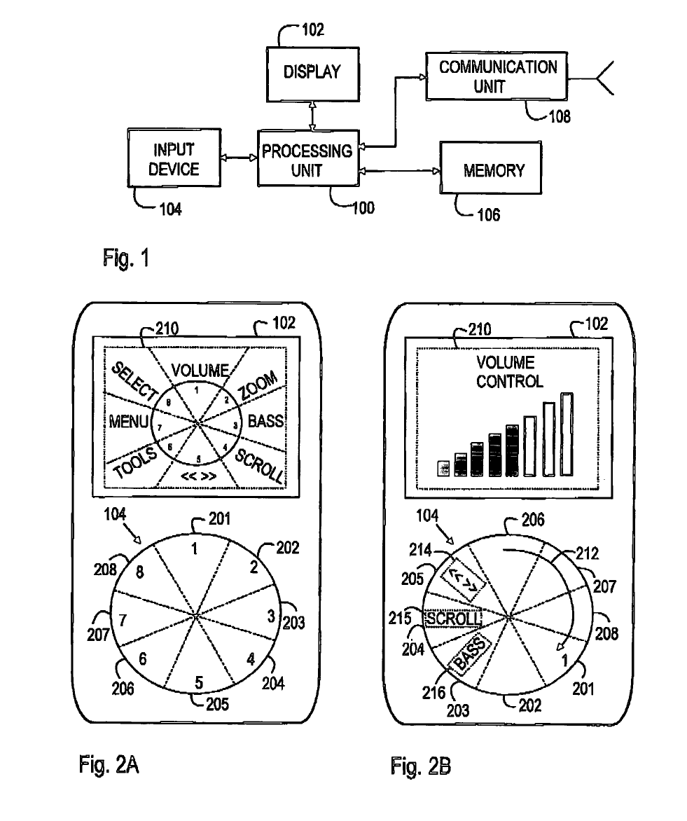

FIG. 1 shows a block diagram of the structure of an electronic device. A processing unit 100, typically implemented by means of a microprocessor and software or separate components, controls the basic functions of the device. A user interface of the device comprises an input device 104 and a display 102, such as a touch screen implemented by manners known per se. In addition, the user interface of the device may include a loudspeaker and a keypad part. Depending on the type of the device, there may be different and a different number of user interface parts. The device of FIG. 1, such as a mobile station, may also include communication means 108 that implement the functions of a mobile station and include speech and channel coders, modulators and RF parts. The device may also comprise an antenna and a memory 106.

The functions of the device are controlled by means of the input de-vice 104, such as a mouse, a hand-held locator operated by moving it on a surface. When using a mouse, for example, a sign or a symbol shows the location of a mouse cursor on the display 102 and often also the function running in the device, or Us state. It is also possible that the display 102 itself is the input device 104 achieved by means of a touch screen such that the desired functions are selected by touching the desired objects visible on the display 102. A touch on the display 102 may be carried out by means of a pen, a stylus or a finger, for example. The input device 104 can also be achieved by using eye-tracking means where detection of eye movements is used in interpreting certain control commands.

The processing unit 100 controls the functions of the user interface and is connected to the display 102, where different application views can be shown. The processing unit 100 receives control commands from the input device 104. The input device 104 is configured to give control commands for controlling software functions, such as browsing application views, of the device. In an embodiment, the input device 102 comprises a control wheel that is used for controlling the software functions of the device. In an embodiment, the software functions of the device are controllable by detected turning functions of the control wheel. For example, adjusting volume, adjusting bass level, selecting functions, starting an application or browsing application views displayed on the display can be operated by means of the control wheel. The application views may be views into different web pages from the Internet, views from any application programs run in the device or any other application views that may be shown on the display 102. Browsing the application views may include scrolling the application view in any direction, for example horizontally or vertically, zooming in to the application view to get a better view of the details of the application view or zooming out from the application view to get a more general view of the whole application view.

In an embodiment of the invention, the processing unit 100 is configured to determine more than one selection areas on the control wheel. The selection areas are associated with given software functions. The processing unit 100 is configured to detect from which selection area a turning function starts when the turning function of the control wheel is detected and to perform predetermined software functions on the basis of from which given selection area the turning function is detected to start.

The processing unit 100 continues to detect control commands indicated by the input device 102, and to detect turning functions of the control wheel. Then, on the basis of the starting point of the turning function, it is determined which software functions are to be performed.

In an embodiment, the processing unit 100 is further configured to provide one or more indication areas displayed on the display 102 for indicating which software functions are associated with given selection areas of the control wheel. It is possible to change the software functions associated with given selection areas to other software functions at any time. The number of selection areas on the control wheel can be set as desired.

In an embodiment, the control wheel can be physically implemented anywhere on the device. The control wheel can be implemented such that one or more touches on the control wheel are detectable by the processing unit 100. The control wheel is implemented such that the turning function of the control wheel can be detected. It is also possible that the control wheel is on the display 102 area and is implemented by means of a touch surface. Thus, the turning function of the control wheel can be detected on the basis of a detected sliding touch on the control wheel. It is possible that the control wheel does not actually “turn” in reality, and that the turning function of the control wheel is only detected on the basis of the detected sliding touch on the control wheel. Thus, “detecting the turning function of the control wheel” can mean A) detecting turning of a physically implemented control wheel of the device or B) detecting turning of a control wheel displayed on a display by means of a touch surface (and where the virtual turning of the control wheel can be shown or not), for example.

In an embodiment, the one or more indication areas are outside the control wheel area on the display 102. The one or more indication areas can also be on one or more selection areas on the control wheel, especially when the control wheel is implemented by using a touch surface on the display 102.

The processing unit 100 is configured to perform predetermined software functions by performing at least one of: volume adjustment, bass level adjustment, a selecting function, a zooming function, a scrolling function, a browsing function, starting an application. Using the control wheel enables control of practically any software functions that can be adjusted.

The processing unit 100 is configured to perform the software functions on the basis of at least one of the following: the detected turning direction of the control wheel, an amount of the detected turning of the control wheel, the speed of the detected turning of the control wheel. Thus, for example, the amount and direction of the turning of the control wheel may determine how much the volume is adjusted and in which direction.

Let us next study embodiments of the invention by means of FIGS. 2A and 2B. FIGS. 2A and 2B show examples of an electronic device comprising a display 102 and an input device that here includes a control wheel 104.

In an embodiment of FIG. 2A, selection areas 201, 202, 203, 204, 205, 206, 207, 208 are provided on the control wheel 104. The areas separated by the dashed lines and numbered from 1 to 8 illustrate the selection areas 201, 202, 203, 204, 205, 206, 207, 208 that are determined on the control wheel 104. Although the selection areas 201, 202, 203, 204, 205, 206, 207, 208 are in this example illustrated with dashed lines and numbered from 1 to 8, there are not necessarily any lines or numbers visible on the control wheel. The number of selection areas 201, 202, 203, 204, 205, 206, 207, 208 can also be adjusted according to the individual needs of the user of the device. The control wheel 104 may also be of any other shape than that of a circle, such as a square, for example. The control wheel 104 may be implemented such that the turning function of the control wheel 104 can be determined. The turning function of the control wheel 104 can be detected on the basis of a continuous touch detected on the control wheel 104 or on the display of the device, for example.

The selection areas 201, 202, 203, 204, 205, 206, 207, 208 are associated with given software functions. In the example of FIG. 2A, the software function of adjusting the volume of the device is associated with the selection area 1 201, the software function of zooming application views is associated with the selection area 2 202, the software function of adjusting the bass is associated with the selection area 3 203, the software function of scrolling application views is associated with the selection area 4 204, the software function of scrolling a play list is associated with the selection area 5 205, the software function of selecting tools is associated with the selection area 6 206, the software function of browsing menu items is associated with the selection area 7 207, and the software function of selecting a specific function is associated with the selection area 8 208. These are just examples of different software functions that can be associated to the selection areas 1 to 8. The user may at any time change these settings and select other software functions to be associated with given selection areas 1 to 8. There may also be different profile settings for many kinds of configurations between selection areas 1 to 8 and software functions. For example, in a music profile there may be only a few specific software functions associated with the corresponding selection areas 1 to 8, such as adjusting the volume, adjusting the bass or browsing a play list.

According to an embodiment, there is also provided an indication area 210 displayed on the display 102 for indicating which software functions are associated with given selection areas 1 to 8 of the control wheel 104. The indication area 210 may include text, pictures, symbols and icons of any kind for indicating the specific software functions that are associated with given selection areas 1 to 8. There may also be other areas for displaying different information, application views or menus on the display 102. The size of the display 102 can be different than in this example. For example, the indication area 210 may cover only a small part of the whole display 102 when the display size is larger. The indication area 210 may also be of any other shape than that of a square, such as a circle, for example. The indication area 210 is used for indicating to the user which selection areas 1 to 8 are associated to which software functions.

For example, if the user wishes to adjust the volume of the device, he/she may first check from the indication area 210 that the specific selection area that is associated with adjusting the volume is the selection area 1 in the upper part of the control wheel 104. The user may then start adjusting the volume of the device by starting to turn the control wheel 104, starting from the selection area 1. The device detects that the turning function of the control wheel 104 has started from the selection area 1, and as this selection area is associated with the software function of adjusting volume, starts to adjust the volume of the device according to the turning function. The turning direction of the turning function then determines whether the volume is increased or decreased. The extent and/or speed of the turning function may determine the how much the volume is increased/decreased. Thus, the direction and the extent of the turning function may define attributes for the software functions. The software functions can be accelerated if the user turns the wheel farther away from the original position. For example, the direction of the turn may define whether the view is zoomed in or out.

If he/she wishes to zoom or scroll an application view displayed on the display, the user may then start turning the control wheel 104, starting from the selection area 2 for zooming or from the selection area 4 for scrolling. The software functions for zooming/scrolling are then performed ac cording to the received control commands from the control wheel 104.

As the user is turning the control wheel 104, the progress of the software function performed can be shown on the display 102. For example, when the volume is adjusted, the display 102 may show the current volume level at the same time. This is illustrated in FIG. 2B.

In the example of FIG. 2B, the control wheel 104 has been turned from its initial position shown in FIG. 2A to a new position. The arrow 212 illustrates how the control wheel 104 has been turned. The user of the device may have moved his/her finger along the route indicated by the arrow 212, for example. The turning function of the control wheel 104 has started from the selection area 1 that is associated with the software function of adjusting the volume. The turning direction is to the right, which means here that the volume is increased.

In an embodiment, it is possible that the appearance of the indication area 210 changes as the turning function starts. In the example of FIG. 2B, the indication area 210 has changed such that it now shows the level of volume as the control wheel 104 is turned. When the user stops turning the control wheel 104, the original appearance of the indication area 210 indicating which software functions are associated with given selection areas 1 to 8 of the control wheel 104 may return.

In an embodiment, it is possible that one or more indication areas 214, 215, 216 is on one or more selection areas 201, 202, 203, 204, 205, 206, 207, 208 on the control wheel 104. The indication areas 214, 215, 216 may, for example, be underneath the control wheel 104 such that it can be seen through the control wheel 104. The control wheel 104 may be at least partly transparent, and the indication area 214, 215, 216 can be seen through the control wheel 104. The information shown on the indication area 214, 215, 216 can be updated at any time. For example, in FIG. 2B, some information about the software functions associated with given selection areas 203 to 205 (<< >>, SCROLL, BASS) is shown on indication areas 214, 215, 216 under the control wheel 104, However, information relating to volume control is shown on the other indication area 210.

Turning the control wheel 104 may be performed by using a finger, a pen or a stylus, for example. If the control wheel 104 is implemented with a touch screen on the display 102 area, then also a mouse can be used for turning the control wheel 104. For example, tapping on the desired selection area and holding a finger down and sliding the finger may turn the control wheel.

In an embodiment, some of the selection areas 1 to 8 may also be operated such that only a touch on the given selection area starts a specific software function. For example, the menu function can be selected just by pressing the selection area 7 207, and then a menu is opened on the display 102. The user may then select a specific function from the menu by moving his/her finger to a specific place on the menu, for example.

The appearance of the control wheel 104, the selection areas 1 to 8 and the indication area 210 may be set as desired. Appropriate colors, text, drawings or fill effects may be used to mark the areas.

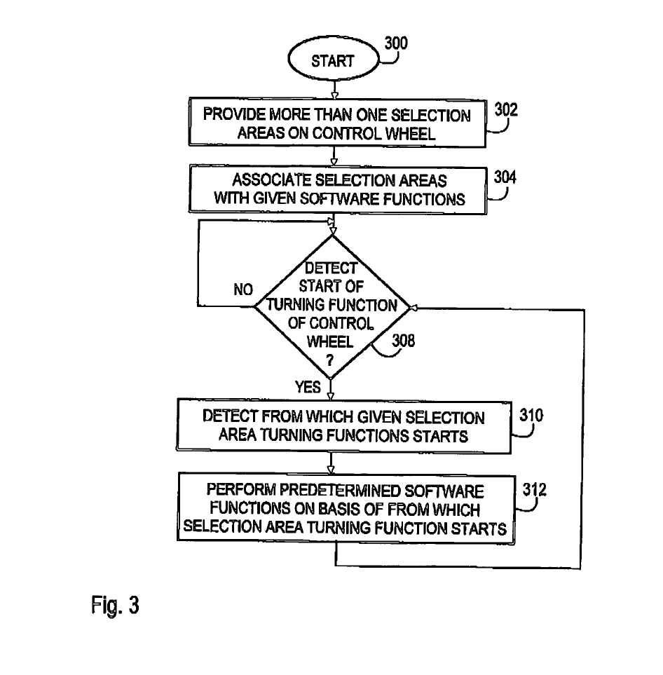

FIG. 3 shows an example of a method of controlling software functions of an electronic device comprising a display and a control wheel, the software functions of the electronic device being controllable by detected turning functions of the control wheel.

The method starts in 300. In 302, more than one selection areas are provided on the control wheel. In 304, the selection areas are associated with given software functions. In 308, if start of a turning function of the control wheel is detected, 310 is entered. If the start of the turning function of the control wheel is not detected, the process continues to detect the occurrence of the turning function.

In 310, it is detected from which given selection area of the control wheel the turning function starts. In 312, predetermined software functions are performed on the basis of from which selection area the turning function has started. The method may be continued by repeating the steps from 308 to 312 until the application is closed, another function is selected or the device is shut down.

The embodiments of the invention may be realized in an electronic device comprising a processing unit operationally connected to an input device, for example. The processing unit may be configured to perform at least some of the steps described in connection with the flowchart of FIG. 3. The embodiments may be implemented as a computer program comprising instructions for executing a computer process for browsing application views in an electronic device.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, or a computer readable compressed software package.

New ways of controlling software functions efficiently with the control wheel were shown in the previous examples. A number of functions can be controlled with the control wheel in a user-friendly manner. More functionality can be fitted in the same space of the control wheel. Further, controlling multiple different functions with the same control wheel becomes faster. In an embodiment, the control wheel does not have to include any permanent selection buttons because the indication area shows which selection areas are associated with specific software functions. The examples shown provide possibilities to steplessly control a number of different software functions with just a single gesture.

Even though the invention has been described above with reference to the examples according to the accompanying drawings, it is clear that the invention is not restricted thereto but can be modified in several ways within the scope of the appended claims.

1. A method of controlling software functions of an electronic device, the electronic device comprising a display and a control wheel, and the software functions of the electronic device being controllable by detected turning functions of the control wheel, the method comprising:
determining more than one selection areas on the control wheel;
associating the selection areas with given software functions;
detecting from which selection area the turning function starts when a turning function of the control wheel is detected; and
performing predetermined software functions on the basis of from which given selection area the turning function is detected to start.

2. The method of claim 1, the method further comprising providing one or more indication areas displayed on the display for indicating which software functions are associated with given selection areas of the control wheel.

3. The method of claim 1, wherein the step of performing predetermined software functions comprises at least one of the following: adjusting the volume, adjusting the bass level, a selecting function, a zooming function, a scrolling function, a browsing function, starting an application.

4. The method of claim 1, wherein the control wheel comprises a touch screen and wherein the step of detecting the selection of the turning direction of the control wheel is based on detected indications from the touch screen.

5. The method of claim 1, wherein the step of performing the software functions is based on at least one of the following: the detected turning direction of the control wheel, the extent of the detected turning of the control wheel, the speed of the detected turning of the control wheel.

6. An electronic device comprising a processing unit for controlling functions of the electronic device; a display coupled to the processing unit; and a control wheel for giving control commands for controlling software functions, the software functions of the electronic device being controllable by detected turning functions of the control wheel, the processing unit being configured to: determine more than one selection areas on the control wheel; associate the selection areas with given software functions; detect from which selection area the turning function starts when a turning function of the control wheel is detected; and perform predetermined software functions on the basis of from which given selection area the turning function is detected to start.

7. The electronic device of claim 6, wherein the processing unit is further configured to provide one or more indication areas displayed on the display for indicating which software functions are associated with given selection areas of the control wheel.

8. The electronic device of claim 7, wherein the one or more indication areas are on the control wheel area or outside the control wheel area.

9. The electronic device of claim 7, wherein the one or more indication areas are on one or more selection areas on the control wheel.

10. The electronic device of claim 6, wherein the processing unit is configured to perform the predetermined software functions by performing at least one of the following: adjusting the volume, adjusting the bass level, a selecting function, a zooming function, a scrolling function, a browsing function, starting an application.

11. The electronic device of claim 6, wherein the input device comprises a touch screen and wherein the processing unit is configured to detect the selection of the turning direction of the control wheel on the basis of detected indications from the touch screen.

12. The electronic device of claim 6, wherein the processing unit is configured to perform the software functions on the basis of at least one of the following: the detected turning direction of the control wheel, the extent of detected turning of the control wheel, the speed of the detected turning of the control wheel.

13. A computer program product encoding a computer process for providing controlling software functions of an electronic device, the computer process comprising controlling the software functions of the electronic device on the basis of detected turning functions of a control wheel, the process further comprising:
determining more than one selection areas on the control wheel;
associating the selection areas with given software functions;
detecting from which selection area the turning function starts when a turning function of the control wheel is detected; and
performing predetermined software functions on the basis of from which given selection area the turning function is detected to start.

14. The computer program product of claim 13, further performing the functions of providing one or more indication areas displayed on the display for indicating which software functions are associated with given selection areas of the control wheel.

15. A computer program distribution medium readable by a computer and encoding a computer program of instructions for executing a computer process for controlling software functions of an electronic device, the process comprising controlling the software functions of the electronic device on the basis of detected turning functions of a control wheel, the process further comprising:
determining more than one selection area on the control wheel;
associating the selection areas with given software functions;
detecting from which selection area the turning function starts when a turning function of the control wheel is detected; and
performing predetermined software functions on the basis of from which given selection area the turning function is detected to start.

16. The computer program distribution medium of claim 15, the distribution medium including at least one of the following mediums: a computer readable medium, a program storage medium, a record medium, a computer readable memory, a computer readable software distribution package, a computer readable signal, a computer readable telecommunications signal, and a computer readable compressed software package.

17. An electronic device comprising processing means for controlling functions of the electronic device; display means; and a control wheel for giving control commands for controlling software functions, the software functions of the electronic device being controllable by detected turning functions of the control wheel, the electronic device further comprising:
processing means for determining more than one selection area on the control wheel;
associating means for associating the selection areas with given software functions;
detecting means for detecting from which selection area the turning function starts when a turning function of the control wheel is detected; and
processing means for performing predetermined software functions on the basis of from which given selection area the turning function is detected to start.

18. The electronic device of claim 17, wherein the device further comprises processing means for providing one or more indication areas displayed on the display for indicating which software functions are associated with given selection areas of the control wheel.
